(19) United States
(12) Patent Application Publication
(10) Pub. No.: US 2011/0042279 A1
(43) Pub. Date: Feb. 24, 2011

(54) DEVICE AND METHOD FOR CLASSIFYING PARTICLES

(75) Inventors: Hiroyuki MORIYA, Kanagawa (JP); Kazuya HONGO, Kanagawa (JP); Hiroshi KOJIMA, Kanagawa (JP); Seiichi TAKAGI, Kanagawa (JP); Tetsuo OHTA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/728,644

(22) Filed: Mar. 22, 2010

(30) Foreign Application Priority Data
Aug. 21, 2009 (JP) 2009-191684

(51) Int. Cl. B03B 5/62

(52) U.S. Cl. 209/155

(57) ABSTRACT

A classification device includes: a classification channel, a particle dispersion delivery channel having an opening for introducing a particle dispersion at one end thereof with the other end connected to the classification channel via a junction, a conveying fluid feed channel having an opening for introducing a conveying fluid at one end thereof with the other end connected to the classification channel, and at least one collection channel for collecting separated particles, the collection channel having an opening at one end thereof with the other end connected to the classification channel, the junction and the classification channel having substantially equal widths, and at least one of the at least one collection channel having a bottom wall with an upwardly convex shape in the middle portion of its width.

### CROSS-REFERENCE TO RELATED APPLICATIONS

This application is based on and claims priority under 35 USC 119 from Japanese Patent Application No. 2009-191684 filed on Aug. 21, 2009.

### BACKGROUND

### Technical Field

This invention relates to a device and a method for classifying particles.

### SUMMARY

According to an aspect of the invention, there is provided a classification device including: a classification channel, a particle dispersion delivery channel having an opening for introducing a particle dispersion at one end thereof with the other end connected to the classification channel via a junction, a conveying fluid feed channel having an opening for introducing a conveying fluid at one end thereof with the other end connected to the classification channel, and at least one collection channel for collecting separated particles, the collection channel having an opening at one end thereof with the other end connected to the classification channel, the junction and the classification channel having substantially equal widths, and at least one of the at least one collection channel having a bottom wall with an upwardly convex shape in the middle portion of its width.

### BRIEF DESCRIPTION OF THE DRAWINGS

Exemplary embodiments of the present invention will be described in detail based on the following figures, wherein:

FIG. 1 is a schematic perspective of an embodiment of the classification device according to the invention;

FIG. 2A and FIG. 2B is each an enlarged fragmentary view of an embodiment of the classification device according to the invention;

FIG. 3A, FIG. 3B, FIG. 3C, FIG. 3D, FIG. 3E, FIG. 3F, and FIG. 3G each show a cross-section of a collection channel used in the classification device of the invention;

FIG. 4 is a schematic perspective of another embodiment of the classification device according to the invention;

FIG. 5 is a schematic perspective of a conventional classification device;

FIG. 6 schematically illustrates sedimentation behavior of particles;

FIG. 7 shows the dimensions of the classifying device fabricated in Example;

FIG. 8 is a particle size distribution histogram of the particle dispersion used in Example; and

FIG. 9 is a graph showing separation efficiency of Example and Comparative Example.

### DESCRIPTION OF NUMERALS AND SYMBOLS

100 Classification device
110 Classification channel
120 Particle dispersion delivery channel
121 Particle dispersion inlet port
130 Conveying fluid feed channel
131 Conveying fluid inlet port
140 Collection channel
141 Collection channel
142 Collection channel
150 Junction
A Particle dispersion
B Conveying fluid

### DETAILED DESCRIPTION

The classification device according to the first aspect of the invention includes a classification channel, a particle dispersion delivery channel having an opening for introducing a particle dispersion at one end thereof with the other end connected to the classification channel via a junction, a conveying fluid feed channel having an opening for introducing a conveying fluid at one end thereof with the other end connected to the classification channel, and at least one collection channel for collecting particles separated in the classification channel, the collection channel having an opening at one end thereof with the other end connected to the classification channel. The junction and the classification channel have substantially equal widths. At least one of the at least one collection channel has an upwardly convex bottom in the middle portion of its width.

The device of the invention will be described in detail with appropriate reference to the accompanying drawings. Unless otherwise noted, the same numerals or symbols designate the same components.

The present inventors have found that when a dispersion is introduced into a flow channel from the upper side of the channel and conveyed through the channel to perform classification of dispersed particles taking advantage of sedimentation of the particles, the particles do not settle while maintaining the particle distribution in the horizontal direction.

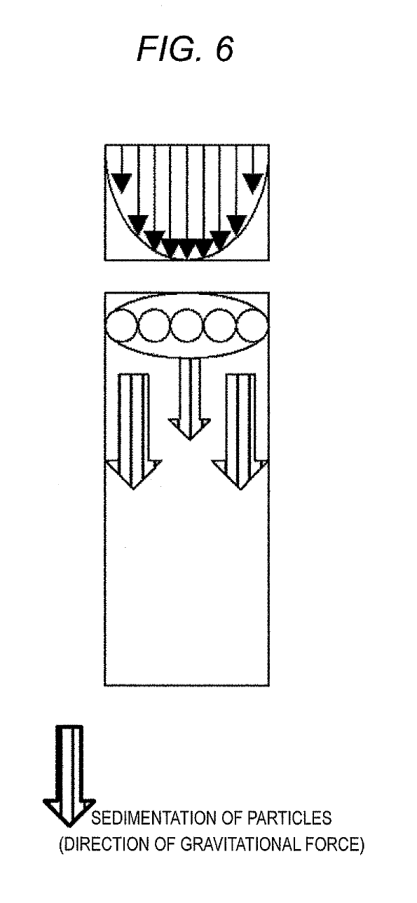

As illustrated in FIG. 6, when particles are present close to the side walls of a channel, the flow of the particles aligned perpendicular to the flow on the same height in the vertical dimension (i.e., particles aligned in the flow width direction on a cross-section of the channel taken parallel to the flow direction) assume a parabolic velocity profile, i.e., plane Poiseuille flow. That is, the flow velocity reaches the maximum in the transverse middle of the channel so that the particles close to the two side walls move slowly in the flow direction as compared with those in the transverse middle of the channel. Therefore, the particles present close to the side walls settle out seemingly rapider than those in the transverse middle of the channel. As a result, the particles depict an inverted U-shaped distribution in a cross-section perpendicular to the flow.

Taking it into consideration that particles present over the whole horizontal dimension of a flow channel show an inverted U-shaped distribution in a cross-section perpendicular to the flow, as illustrated in FIG. 6, the present inventors have succeeded in achieving high separation efficiency by shaping a collection region, where a fraction of the particle dispersion is collected, in conformity with this particle distribution profile.

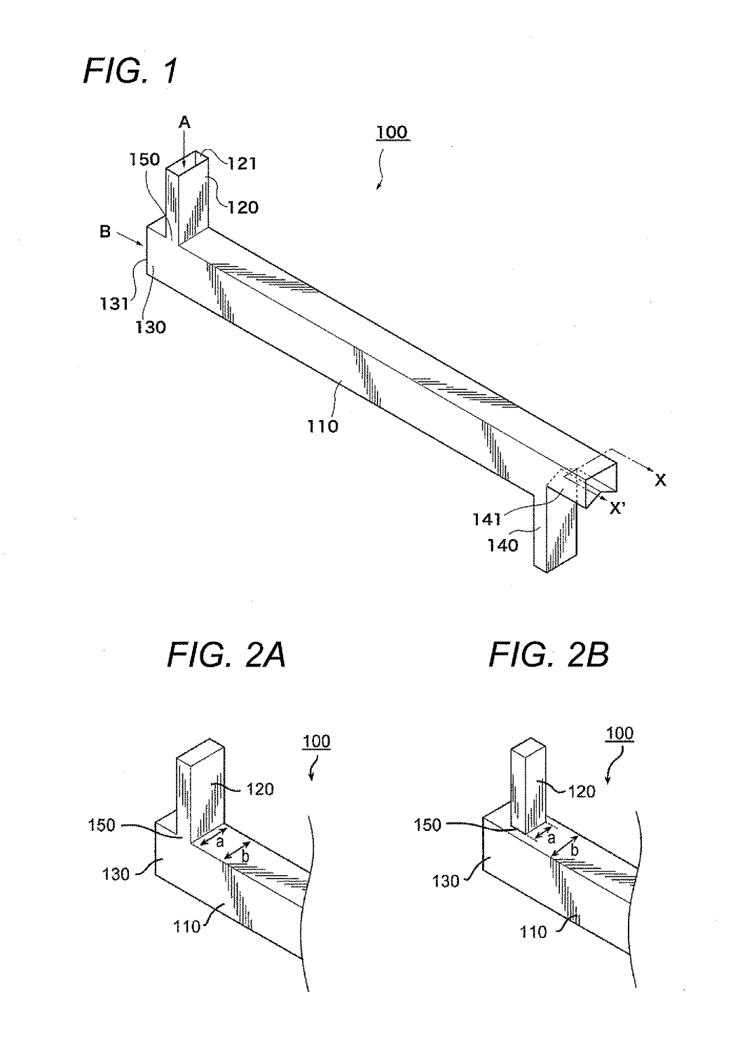

FIG. 1 is a schematic perspective of a classification device 100 incorporating an exemplary embodiment of the invention.

The device 100 shown in FIG. 1 includes a classification channel 110 that conveys a particle dispersion A and a conveying fluid B in laminar flow having the particle dispersion A in the upper stream and the conveying fluid B in the lower stream.

A particle dispersion delivery channel 120 and a conveying fluid feed channel 130 are provided upstream of the classification channel 110. The particle dispersion delivery channel 120 has an opening for introducing a particle dispersion (hereinafter referred to as a particle dispersion inlet port) 121 at one end thereof with the other end connected to the classification channel 110 via a junction 150. The conveying fluid feed channel 130 has an opening for introducing a conveying fluid (a conveying fluid inlet port) 131 at one end thereof with the other end connected to the classification channel 110.

The particle dispersion delivery channel 120 is provided to communicate with the upper stream in the classification channel 110, while the conveying fluid feed channel 130 is provided to communicate with the lower stream of the classification channel 110. The classification channel 110 conveys the particle dispersion and the conveying fluid in laminar flow having the particle dispersion in the upper stream and the conveying fluid in the lower stream. The number of streams in the laminar flow formed in the classification channel is not limited to two as in the present embodiment, and the laminar flow may have another stream of different fluid between the particle dispersion stream and the conveying fluid stream. Anyway, the particle dispersion delivery channel 120 and the conveying fluid feed channel 130 are preferably connected to the classification channel 110 so that the particle dispersion may be on or above the conveying fluid.

Particles in the particle dispersion settle by gravity while being conveyed in the classification channel 110. When the particles present in the particle dispersion have uniform specific gravity, gravity will cause rapider sedimentation of larger particles than smaller ones while being carried downstream in the classification channel 110 according to Stokes equation. Downstream of the classification channel 110 is provided at least one collection channel for collecting the separated (classified) particles with its one end open and the other end connected to the classification channel. While the device illustrated in FIG. 1 has two collection channels 140 and 141, the number of the collection channels is not limited to two as long as there is at least one collection channel. It is preferred that two or more collection channels be provided.

The device 100 of the present embodiment also includes a junction 150 between the particle dispersion delivery channel 120 and the classification channel 110.

In the invention, the longest dimension of the channel at the junction measured perpendicular to the direction of gravitational force and perpendicular to the flow direction in the classification channel on the cross-section of the junction taken parallel to the flow direction in the classification channel will be referred to as “channel width” or simply “width” of the junction, and the longest dimension of the classification channel measured perpendicular to the direction of gravitational force and perpendicular to the flow direction in the classification channel on a cross-section taken perpendicular to the flow direction will be referred to as “channel width” or simply “width” of the classification channel.

In the invention, the junction 150 and the classification channel 110 have substantially equal widths.

Each of FIGS. 2A and 2B is an enlarged fragmentally view of the junction 150 of the classification device 100. The channel width of the junction 150 and that of the classification channel 110 are indicated by symbols a and b, respectively. In FIG. 2A, the channel width a at the junction 150 and the channel width b of the classification channel 110 are equal. In FIG. 2B, the channel width a at the junction 150 is smaller than the channel width b of the classification channel 110.

When the junction 150 and the classification channel 110 have “substantially equal” channel widths, the term “substantially equal” means that the channel widths a and b satisfy the relationship: 0.8×a≦b≦1.2×a. It is preferred for the widths a and b satisfy the relationship: 0.9×a≦b≦1.1×a, more preferably 0.95×a≦b≦1.05×a, even more preferably a=b.

When the width b of the classification channel 110 is less than 0.8 times the width a of the junction 150, the width a at the junction 150 is too larger than the width b of the classification channel 110, which can cause particles to accumulate at the shoulder between the junction 150 and the classification channel 110 to cause clogging. When the width b of the classification channel 110 is larger than 1.2 times the width a at the junction 150, the particle dispersion is less likely to be spread transversely over the whole width of the classification channel, resulting in a failure of the particles to show the distribution implied in FIG. 6 and to obtain the effect of the invention.

In the invention, the collection channel has a bottom wall upwardly convex at the middle of its channel width.

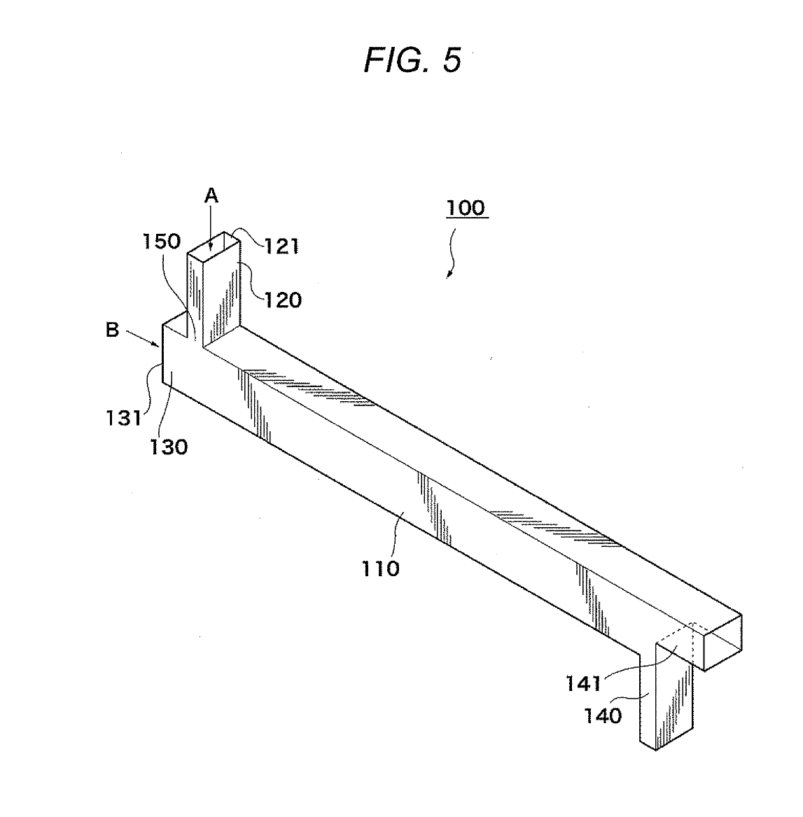

FIG. 5 is a schematic perspective of a conventional classification device. The conventional classification device has a collection channel provided as if to divide the classification channel by cutting in the horizontal direction as illustrated in FIG. 5. In the device of FIG. 5, the fluid flowing as an upper stream is collected through a collection channel 141, while the fluid flowing as a lower stream is collected through a collection channel 140. However, since the particles has an inverted U-shaped distribution on a cross-section perpendicular to the flow direction as implied in FIG. 6, particles at the portions being close to the side walls of the classification channel are incorporated into the collection channel 140, although particles having same particle size at the transverse middle portion of the classification channel are collected through the collection channel 141, so that it results in a failure of sufficient separation efficiency.

The invention accomplishes particle classification in a profile near the flow distribution thereby to obtain high separation efficiency by using a collection channel the bottom wall of which is upwardly convex in the middle portion of its channel width. Making the collection channel's bottom shape upwardly convex in the middle portion of the channel width is aimed at collecting particles in conformity to the flow distribution profile. Hence, the shape of a channel downstream the collection channel is not particularly limited.

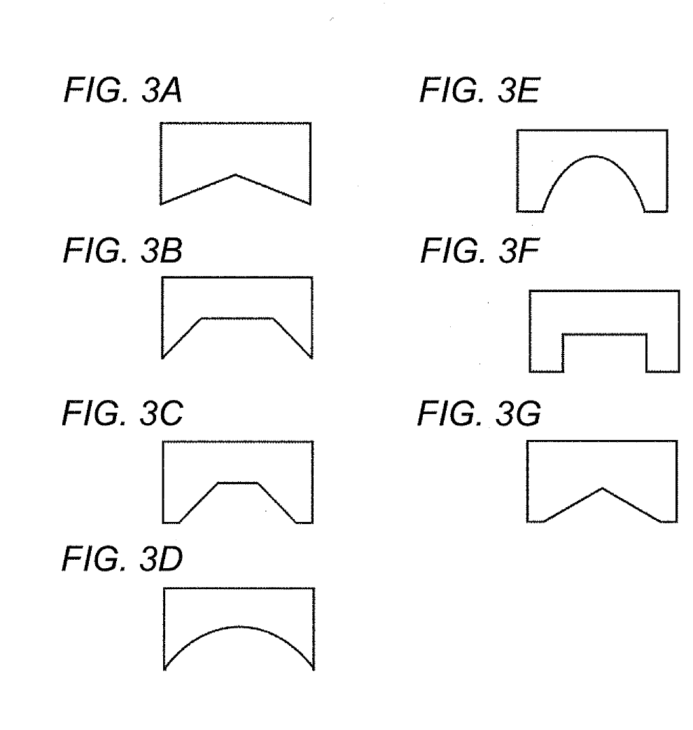

FIG. 3A is a cross-section taken along line x-x′ in FIG. 1, showing a cross-section of the collection channel. As illustrated in FIG. 3A, the collection channel 141 of the classification device 100 of FIG. 1 has an inverted V-shaped bottom wall in its cross-section. The cross-sectional bottom wall shape of the collection channel is not particularly limited as long as it is upwardly convex in its transverse middle portion. FIGS. 3B through 3G provide examples of such an upwardly convex shape. Specifically, the bottom shape may be an isosceles trapezoid bridging the whole channel width as in FIG. 3(B), or the transverse middle portion of the bottom may be isosceles trapezoidal as in FIG. 3(C); the bottom may be an arc bridging over the whole channel width as in FIG. 3D, or the transverse middle portion of the bottom may be arcuate as in FIG. 3E. The transverse middle portion of the bottom may be rectangular or inverted V-shaped as in FIG. 3F or 3G, respectively. Particularly preferred of these cross-sectional shapes is the one having an arc in the transverse middle portion of the bottom as illustrated in FIG. 3E in terms of separation efficiency.

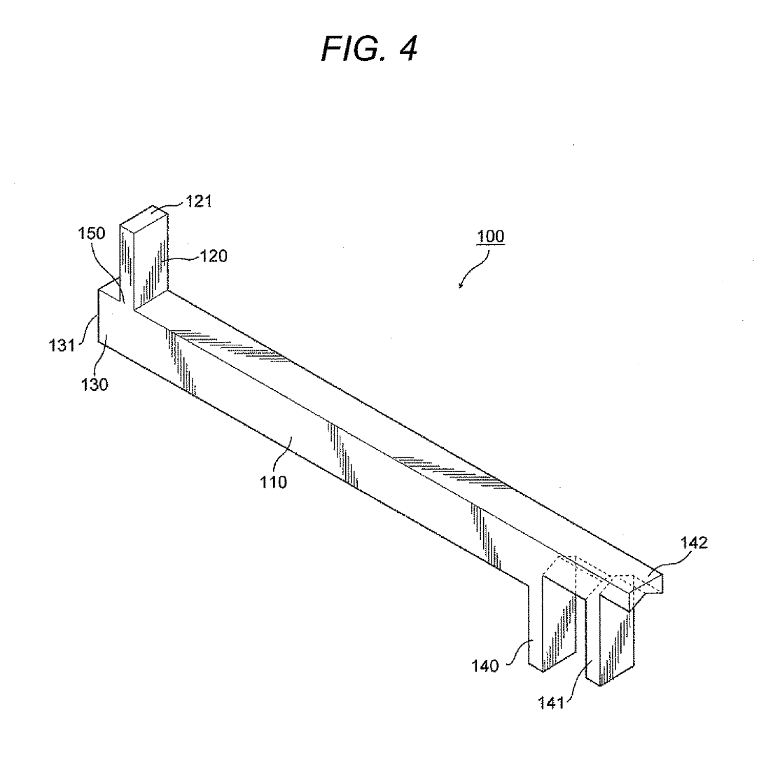

FIG. 4 is a schematic perspective of another embodiment of the classification device according to the invention. The classification device 100 of FIG. 4 has three collection channels 140, 141, and 142. Both the collection channels 141 and 142 have an inverted V-shaped bottom wall. The lower end of each leg of the inverted V directly connects to each side wall of the respective collection channel.

When the classification device of the invention has two or more collection channels, it is only necessary that at least one of the collection channels have an upwardly convex bottom wall in the middle of its width, it is preferred that all the collection channels have an upwardly convex bottom wall in the middle of their width as in the embodiment illustrated in FIG. 4.

It is preferred that any of the classification channel, the particle dispersion delivery channel, the conveying fluid feed channel, and the collection channel (s) be a microchannel. As used herein, the term “microchannel” denotes a channel having a hydraulic diameter that is generally in the range of from 50 to 5000 μm. The channel width of the microchannel is preferably 50 to 1000 μm, more preferably 50 to 500 μm. The classification device of the invention is preferably composed of a plurality of microscale channels. A microscale channel has a small size and a low flow velocity. A Reynolds number (Re) of the flow in the classification device according to the invention is 2,300 or less. Accordingly, the device of the invention is of the type not governed by turbulent flow as in the case of an ordinary classification device or apparatus but by laminar flow.

As used herein, the term “Reynolds number (Re)” is a dimensionless number represented by equation: Re=uL/ν, where u is a flow velocity; L is a representative length; and ν is a dynamic velocity. When a flow has a Reynolds number of 2,300 or less, it is a laminar flow.

In the field governed by laminar flow, particles dispersed in a liquid medium (dispersion medium) and heavier than the medium settle through the medium. The sedimentation velocity of the particles varies depending on the specific gravity or size of the particles. In the invention, the difference in sedimentation velocity is made use of to effect classification. The mechanism described is particularly suited to classify particles varying in size because the sedimentation velocity is proportional to the square of the particle size so that the larger the particle size the rapider the particles settle. On the other hand, in the case where the channel has a large cross-sectional dimension to produce a turbulent flow, the position of particles' sedimentation varies, basically resulting in a failure of classification.

The length of the classification channel is decided as appropriate to the level of difficulty of particle classification, for example, the breadth of particle size distribution or difference in specific gravity between liquid medium and particles. In general, when the difference between the specific gravity of the liquid medium and the conveying fluid and the specific gravity of particles to be classified is small, it is preferred to increase the length of the classification channel.

The classification channel may have any cross-sectional shape, such as rectangular, trapezoidal, circular, or the like. A rectangular shape is preferred in view of ease of fabricability and machinability.

In carrying out particle classification with the device of the invention, the particle dispersion is preferably made to flow downward in the inclined classification channel 110, which is advantageous for the following reason. In the case where the dispersion is conveyed in a horizontal direction, the particles having settled in the classification channel can accumulate on the bottom of the classification channel. In a microfluidic channel, in particular, the flow velocity on the wall of the channel is almost zero, easily allowing the particles to accumulate. When the bottom surface of the classification channel is inclined, the particles having settled thereon move downward along the bottom surface by the gravitational influence, whereby accumulation of the particles and resultant clogging of the channel can be prevented.

The direction of the flow in the particle dispersion delivery channel is preferably inclined from the horizontal so that the dispersion may flow downward, particularly in the direction of gravitational force. Taking the horizontal angle as 0° and the angle of the direction of gravitational force as 90°, the angle of the flow in the particle dispersion delivery channel is preferably greater than 0° and not greater than 135°, more preferably 10° to 120°, even more preferably 20° to 110°. By designing the particle dispersion delivery channel to make a fluid flow at an angle greater than 0°, channel clogging by the particles is prevented. The clogging problem is least likely to occur at an angle of 90°.

The angle of the flow in the classification channel is preferably greater than 0° and smaller than 90°, more preferably 10° to 80° even more preferably 20° to 70°, most preferably 30° to 60°. As stated above, particles having settled on the bottom wall of the classification channel are conveyed downward successfully in a flow with an angle greater than 0°. With the angle of the flow being less than 90° good classification accuracy is secured.

Similarly to the flow of the particle dispersion delivery channel, the angle of the flow in the collection channels is preferably greater than 0° and not greater than 90°, more preferably 10° to 90°, even more preferably 20° to 90°, and most preferably 90° (i.e., the direction of gravitational force). With the angle of the flow being 90°, the clogging problem is least likely to occur.

The direction of the flow of the conveying fluid through the conveying fluid feed channel, where a particle-free conveying liquid is delivered, is not particularly limited.

In FIG. 1, when the particle dispersion A containing coarse particles and fine particles is delivered to the classification channel 110, the coarse particles settle rapider than the fine particles and are therefore collected through the collection channel 140 that is provided upstream the collection channel 141, whereas the fine particles that settle slower are collected through the collection channel 141. Thus, there are obtained a coarse particle fraction T1 (a collected fluid having a higher content of coarse particles than the particle dispersion delivered) through the collection channel 140 and a fine particle fraction T2 (a collected fluid having a higher content of fine particles than the particle dispersion delivered) through the collection channel 141.

The particle dispersion and the conveying fluid may be introduced into the particle dispersion delivery channel and the conveying fluid feed channel, respectively, by any method but are preferably introduced under pressure using, e.g., a microsyringe, a rotary pump, a screw pump, a centrifugal pump, a piezoelectric pump, a gear pump, a mohno pump, a plunger pump, or a diagram pump.

If the particle dispersion is left to stand still before it is delivered, the particles settle out, making it difficult to feed a uniform particle dispersion. Therefore, the particle dispersion is preferably fed while being stirred, ultrasonicated, shaken, or in other ways. For example, the particle dispersion is placed in a syringe equipped with a stirring bar, which is rotated by a stirrer outside the syringe so that the particle dispersion may be delivered in a uniform state.

The flow velocity of the particle dispersion in the particle dispersion delivery channel is preferably 0.001 to 500 ml/hr, more preferably 0.01 to 300 ml/hr.

The flow velocity of the conveying fluid in the conveying fluid feed channel is preferably 0.002 to 5,000 ml/hr, more preferably 0.1 to 3,000 ml/hr.

The material making the classification device is not particularly limited and may be chosen as appropriate for, for example, the liquid medium to be conveyed from among generally employed materials, such as metals, ceramics, plastics, and glass.

The classification device of the invention may be made by any known method. For example, the device may be fabricated from solid substrates using established micromachining technology. Materials that can be used as a solid substrate include metals, silicon, Teflon™, glass, ceramics, and plastics. Preferred of them are metals, silicon, Teflon, glass, and ceramics in view of their resistance to heat, pressure, and solvent and transparency to light. Glass is the most preferred.

Examples of micromachining technology include methods described in Microreactor Shinjidaino Gouseigijutu, supervised by Junichi Yoshida, CMC Publishing Co., Ltd. (2003) and Bisaikakougijutu Ohyohen—Photonics Electronics Mechatronics eno Ohyo, edited by Gyouji Iinkai of The Society of Polymer Science, Japan, NTS, Inc. (2003).

Representative micromachining methods include LIGA using X-ray lithography, high aspect ratio photolithography using EPON SU-8, micro electric discharge machining (also known as μ-EDM), high aspect ratio machining of silicon based on Deep RIE, hot embossing, stereo lithography, laser machining, ion beam machining, and mechanical micro cutting using a microtool made of a hard material, such as diamond. These methods may be used singly or in combination. Preferred of them are LIGA using X-ray lithography, high aspect ratio photolithography using EPON SU-8, μ-EDM, and mechanical micro cutting.

The microchannels of the classification device may be formed by molding a resin in a mold fabricated on a silicon wafer by using a photoresist. In this case, a silicone resin exemplified by polydimethylsiloxane or its derivative is used as a molding resin.

The classification device of the invention may be fabricated by making use of various bonding techniques. General bonding techniques are roughly divided into solid-phase bonding processes and liquid-phase bonding processes. Typical examples of usually employed bonding methods include pressure welding and diffusion bonding (both of which are solid phase bonding processes), welding, eutectic bonding, soldering, and adhesion (all of which are liquid phase bonding processes).

It is desirable to select a highly precise bonding technique assuring high dimensional accuracy without involving destruction of micro structures, such as microchannels, due to material deterioration or deformation caused by heating at high temperatures. Examples of such a technique include direct silicon bonding, anodic bonding, surface activation bonding, direct bonding using hydrogen bonding, bonding using an aqueous HF solution, Au—Si eutectic bonding, and void-free adhesion.

The classification device of the invention may also be fabricated by building up patterned thin films (layers). The thickness of each patterned layer is preferably 5 to 50 μm, more preferably 10 to 30 μm. The classification device of the invention may be a device fabricated by building up patterned layers having a predetermined two-dimensional pattern. The patterned layers may be directly joined on their planes.

Among the above described methods using a bonding technique is a method including the steps of (1) forming a plurality of patterned layers each corresponding to a cross-sectional shape of a contemplated classification device on a first substrate (donor substrate fabrication step), (2) bringing a second substrate into contact with a patterned layer formed on the first substrate and then releasing the second substrate from the first substrate to transfer the patterned layer to the second substrate (bonding step), and repeating the bonding step for each of the other patterned layers. For the details, reference can be made to, e.g., JP 2006-187684A.

The particle dispersion that is subjected to classification according to the invention contains particles having a larger specific gravity than each of the liquid medium, i.e., the dispersion medium of the particle dispersion and the conveying fluid. The particle dispersion preferably contains particles having a volume average particle size of 0.1 to 1,000 μm, and the difference in specific gravity between the particles and the liquid medium is preferably 0.01 to 20.

The dispersed particles may be of any materials including resins, inorganic substances, metals, and ceramics as long as their volume average particle size ranges from 0.1 to 1000 μm. The volume average particle size of the particles is preferably 0.1 to 1,000 μm, more preferably 0.1 to 500 μm, even more preferably 0.1 to 200 μm, most preferably 0.1 to 50 μm. Particles with a volume average particle size of 1,000 μm or smaller are less likely to cause clogging. Particles with a volume average particle size of 1,000 μm or smaller have an advantageous sedimentation velocity for preventing accumulation on the bottom wall of channels and resulting clogging. Particles with a volume average particle size of 0.1 μm or greater hardly interact with the inner wall of the channels and are thereby prevented from adhering thereto.

Although the particles may have any shape, it can be likely that acicular particles whose length exceeds ¼ the width (shorter one of the two dimensions of a cross-section taken perpendicular to the flow direction) of any channel cause clogging of the channel. In view of this, the aspect ratio (length to breadth ratio) of the particles is preferably 1 to 50, more preferably 1 to 20. The channel widths are preferably decided according to the size and shape of the particles to be treated.

Types of particles that can be treated in the invention include, but are not limited to, polymer particles, crystals or agglomerates of organic substances (such as pigments) or inorganic substances, metal particles, and particles of metallic compounds, such as metal oxides, metal sulfides, and metal nitrides.

Examples of the polymer of the polymer particles include polyvinyl butyral resins, polyvinyl acetal resins, polyarylate resins, polycarbonate resins, polyester resins, phenoxy resins, polyvinyl chloride resins, polyvinylidene chloride resins, polyvinyl acetate resins, polystyrene resins, acrylic resins, methacrylic resins, styrene-acrylic resins, styrene-methacrylic resins, polyacrylamide resins, polyamide resins, polyvinyl pyridine resins, cellulosic resins, polyurethane resins, epoxy resins, silicone resins, polyvinyl alcohol resins, casein, vinyl chloride-vinyl acetate copolymers, modified vinyl chloride-vinyl acetate copolymers, vinyl chloride-vinyl acetate-maleic anhydride copolymers, styrene-butadiene copolymers, vinylidene chloride-acrylonitrile copolymers, styrene-alkyd resins, and phenol-formaldehyde resins. Composite particles of the polymer described above are also useful. The composite particles contain, in the polymer particles, crystals or agglomerates of an organic compound (e.g., a pigment) or an inorganic compound, metal particles, particles of a metallic compound (e.g., oxide, sulfide, or nitride), or various additives, such as a dispersant and an antioxidant.

Examples of the metal or metallic compound of the particles include carbon black, zinc, aluminum, copper, iron, nickel, chromium, titanium; alloys of these metals; metal oxides, such as TiO₂, SnO₂, Sb₂O₃, In₂O₃, ZnO, MgO, and iron oxide, and compounds thereof; metal nitrides, such as silicon nitride; and combinations thereof.

The particles may be produced by a variety of methods. In most cases, particles are synthesized in a liquid medium, and the resulting dispersion is subjected as such to particle classification. Particles obtained by mechanically grinding a massive solid may be dispersed in a liquid medium to make a dispersion to be classified. When the grinding is conducted in a liquid medium, as is often the case, the resulting dispersion is subjected to classification as such.

In the case where powder (particles) prepared by dry process is to be classified, the powder should be dispersed in a liquid medium beforehand. The powder may be dispersed using a sand mill, a colloidal mill, an attritor, a ball mill, Dyne Mill™, a high pressure homogenizer, an ultrasonic homogenizer, CoBall Mill™, a roll mill, and so forth. The dispersing conditions are preferably selected so that the primary particles may not be ground.

As previously stated, the difference in specific gravity between the particles and the liquid medium (difference obtained by subtracting the specific gravity of the liquid medium from that of the particles) is preferably 0.01 to 20. The difference is more preferably 0.05 to 11, even more preferably 0.05 to 4. With the difference being 0.01 or greater, the particles exhibit good sedimentation behavior. With difference being 20 or smaller, the particles are easy to convey.

The liquid medium is preferably chosen so as to give a specific gravity difference from the particles in the range recited above. Examples of suitable liquid media include water, aqueous media, and organic solvent media.

The term “water” as used herein is intended to include ion exchanged water, distilled water, and electrolyzed ionic water. Examples of the organic solvent media include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, toluene, xylene, and mixtures of two or more thereof.

Preference for the liquid medium varies according to the particles. For example, liquid media that are preferably combined with polymer particles, the specific gravity of which generally ranges from about 1.05 to about 1.6, include aqueous media that do not dissolve the particles, organic solvents, such as alcohols and xylene, and acidic or alkaline water. Liquid media that are preferably combined with metal or metallic compound particles, the specific gravity of which generally ranges from about 2 to about 10, include water that does not attack the particles through, e.g., oxidation or reduction, organic solvents, such as alcohols and xylene, and oils.

Preferred combinations of particles and liquid media are a combination of polymer particles and an aqueous medium and a combination of metal or metallic compound particles and a low viscosity oily medium. The combination of polymer particles and an aqueous medium is especially suited. Examples of polymer particles/aqueous medium combinations include styrene-acrylic resin particles/aqueous medium, styrene-methacrylic resin particles/aqueous medium, and polyester resin particles/aqueous medium.

The particle dispersion preferably has a content of particles of 0.01% to 40%, more preferably 0.05% to 25%, by volume. As long as the particle concentration is at least 0.01 vol %, the particles are easy to collect . With the particle concentration not exceeding 40 vol %, channel clogging is prevented.

According to the present invention, good classification accuracy can be achieved even with a particle dispersion having a relatively high particle concentration that has been difficult to classify by conventional techniques. In particular, the invention allows for highly accurate classification of a particle dispersion having a particle concentration of 1.0 vol % or more that has been difficult to classify by a conventional classification method using a pinched channel or a centrifugal force.

As used herein, the term “volume average particle size” denotes a value measured with a Coulter counter TA-II from Coulter Electronics, Inc., except for particles having a particle size of 5 μm or smaller. In the measurement with TA-II Coulter counter, a suitable aperture diameter is chosen according to the particle size level. Particle size measurement for the particles with a particle size of 5 μm or smaller is carried out using a laser diffraction scattering particle size analyzer LA-920 from Horiba, Ltd.

The specific gravity of the particles is measured by a gas displacement technique using a pycnometer Ultrapycnometer 1000 from Yuasa Ionics Co., Ltd. The specific gravity of the liquid medium is measured with a specific gravity measuring kit AD-1653 from A & D Co., Ltd.

The conveying fluid used in the classification method of the invention is a liquid containing no particles to be classified. It is preferred that the conveying fluid be the same as the liquid medium of the particle dispersion. In the case where the conveying fluid is not the same as the liquid medium, the conveying fluid is preferably selected from the examples recited above with respect to the liquid medium.

The same preference for the specific gravity of the liquid medium relative to that of the particles applies to the specific gravity of the conveying fluid.

It is preferred for the particle dispersion to contain a surfactant in addition to the particles and the dispersion medium. The surfactant is adsorbed to the surface of the particles in the dispersion to provide a finely dispersed and stabilized dispersion, whereby the dispersed particles are prevented from agglomerating. The surfactant is also effective in preventing the particles from electrostatically clinging to the inner walls of the channels.

The surfactant to be added is not limited and may be selected appropriately according to the particles from among cationic, anionic, amphoteric, and nonionic surfactants. Examples of useful cationic surfactants include quaternary ammonium salts, alkoxylated polyamines, aliphatic amine polyglycol ethers, aliphatic amines, di- and polyamines derived from aliphatic amines and aliphatic alcohols, imidazolines derived from fatty acids, and salts of these cationic substances. The cationic surfactants maybe used either individually or in combination of two or more thereof.

Examples of useful anionic surfactants include N-acyl-N-methyltaurine salts, fatty acid salts, alkylsulfuric ester salts, alkylbenzenesulfonic acid salts, alkylnaphthalenesulfonic acid salts, dialkylsufosuccinic acid salts, alkylphosphoric ester salts, naphthalenesulfonic acid formalin condensates, and polyoxyethylene alkylsulfuric ester salts. Inter alfa, N-acyl-N-methyltaurine salts and polyoxyethylene alkylsulfuric ester salts are preferred. The cation forming the salt is preferably an alkali metal cation. These anionic surfactants may be used either individually or in combination of two or more thereof.

Examples of useful nonionic surfactants include polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkylamines, and glycerol fatty acid esters. Among them preferred are polyoxyethylene alkyl aryl ethers. These nonionic surfactants may be used either individually or in combination of two or more thereof.

In treating a resin particle dispersion, in particular, it is preferred to use an anionic surfactant, more preferably an N-acyl-N-methyltaurine salt, a fatty acid salt, an alkylsulfuric ester salt, an alkylbenzenesulfonic acid salt, an alkylnaphthalenesulfonic acid salt, an alkylphosphoric ester salt, a polyoxyethylene alkylsulfuric ester salt, or the like.

The amount of the surfactant to be added is preferably, but not limited to, 0.0001% to 20% by weight, more preferably 0.001% to 10% by weight, even more preferably 0.005 to 5% by weigh, based to the total solids content of the particle dispersion so as to ensure the improvement in uniformity and stability of the disperse state.

The invention will now be illustrated in greater detail with reference to Example in view of Comparative Example, but it should be understood that the invention is not deemed to be limited thereto.

### Example 1

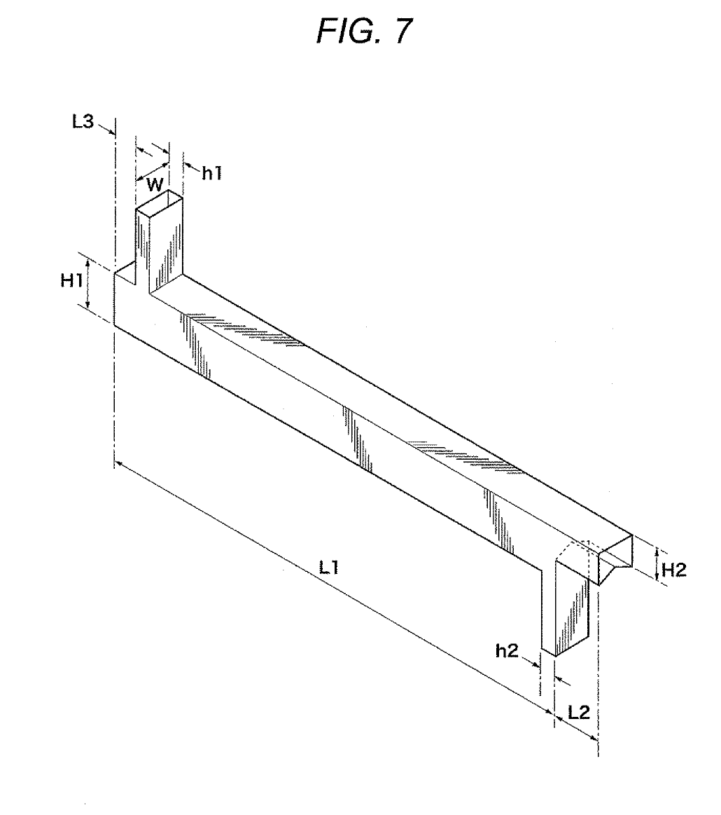

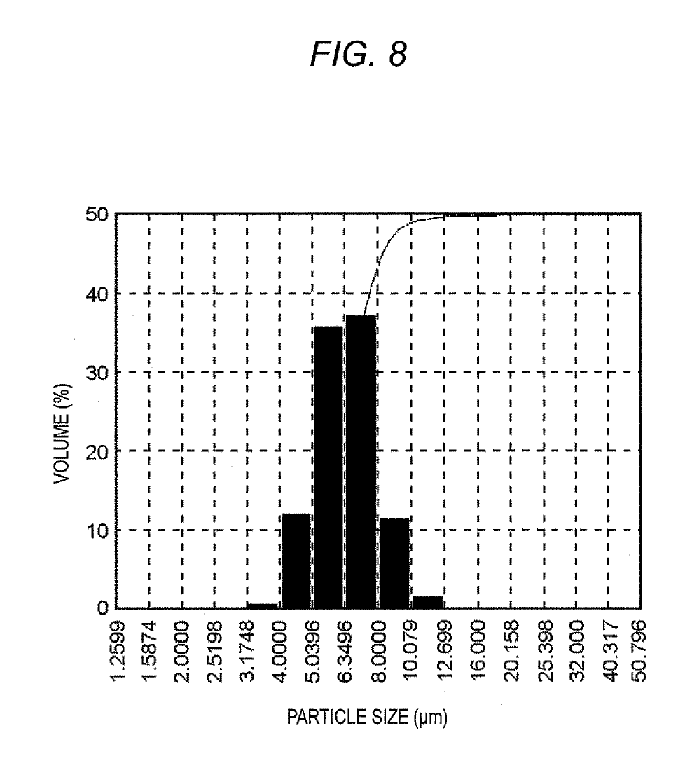

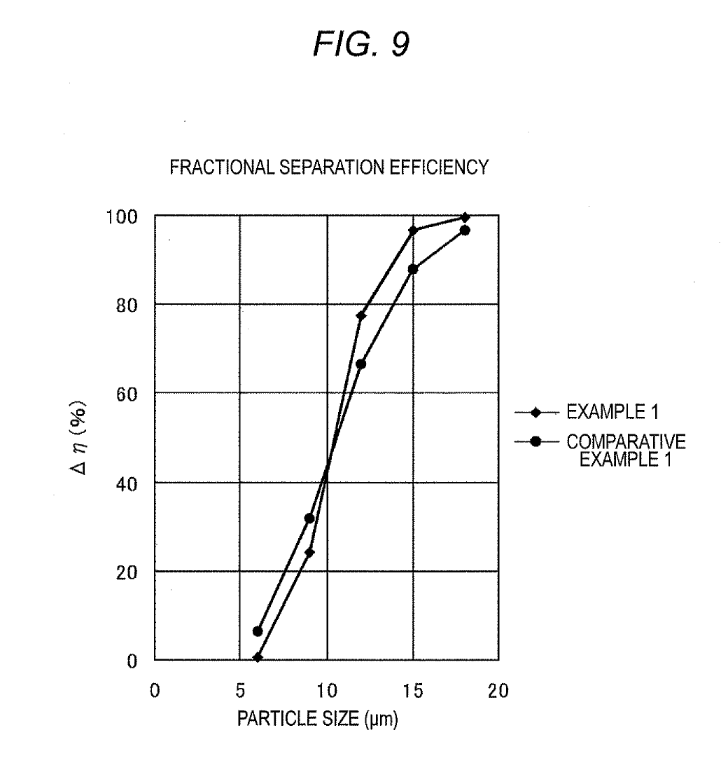

A classification device (microchannel device) incorporating the embodiment of FIG. 1 is fabricated using an acrylic resin. FIG. 7 shows the dimensions of the classifying device fabricated in Example 1. The classification channel has a width (W) of 0.5 mm and a depth or height (H1) of 2 mm. The total length (L1) of the classification channel and the conveying fluid feed channel is 50 mm. The conveying fluid feed channel has a length (L3) of 10 mm. The collection channel 141 has a length (L2) of 5 mm and is provided at a depth (H2) of 1 mm from the top of the side walls of the classification channel. The bottom wall of the collection channel 141 has an inverted V shape with a vertex angle of 48°. A particle dispersion containing 1.4% by volume of spherical polyester particles having the size distribution of FIG. 8, an average particle size of 5.8 μm, and a specific gravity of 1.16 g/cm³ is fed from the particle dispersion inlet port 121 at a flow rate of 1 ml/hr, and water is fed from the conveying fluid inlet port 131 at a flow rate of 50 ml/hr. The separated particles are collected through the collection channels 140 and 141. As a result, the fractional efficiency curve shown in FIG. 9 is obtained.

The particle dispersion delivery channel 120 has a width of 0.5 mm, which is equal to the width (W) of the classification channel 110, and a depth (h1) (the dimension perpendicular to the width and perpendicular to the flow direction in the channel 120) of 0.04 mm. The collection channel 140 has a width of 0.5 mm, which is equal to the width (W) of the classification channel, and a depth (h2) (the dimension perpendicular to the width and perpendicular to the flow direction in the channel 140) of 1.32 mm.

### Comparative Example 1

A separation test is performed in the same manner as in Example 1, except that the collection channel 141 has a flat bottom wall as illustrated in FIG. 5 and is provided at a position at a depth (h2) of 0.8 mm from the top of the side walls of the classification channel. The resulting fractional separation efficiency curve is shown in FIG. 9.

The particle dispersion delivery channel 120 has a width of 0.5 mm, which is equal to the width (W) of the classification channel 110, and a depth (h1) (the dimension perpendicular to the width and perpendicular to the flow direction in the channel 120) of 0.04 mm. The collection channel 140 has a width of 0.5 mm, which is equal to the width (W) of the classification channel, and a depth (h2) (the dimension perpendicular to the width and perpendicular to the flow direction in the channel 140) of 1.24 mm.

As can be seen from FIG. 9, the curve of Example 1 is steeper than that of Comparative Example 1, indicating more efficient classification.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A classification device comprising:
a classification channel,
a particle dispersion delivery channel having an opening that introduces a particle dispersion at one end thereof with other end connected to the classification channel via a junction,
a conveying fluid feed channel having an opening that introduces a conveying fluid at one end thereof with other end connected to the classification channel, and
at least one collection channel that collects separated particles, the collection channel having an opening at one end thereof with other end connected to the classification channel,
the junction and the classification channel having substantially equal widths, and
at least one of the at least one collection channel having a bottom wall with an upwardly convex shape in a middle portion of a width of the collection channel.

2. The classification device according to claim 1, wherein the at least one collection channel comprises two or more collection channels.

3. The classification device according to claim 1, wherein the junction and the classification channel satisfy the following relationship:
0.8×a≦b≦1.2×a
where a is the channel width of the junction; and b is the channel width of the classification channel.

4. The classification device according to claim 1, wherein the junction and the classification channel satisfy the following relationship:
0.9×a≦b≦1.1×a
where a is the channel width of the junction; and b is the channel width of the classification channel.

5. The classification device according to claim 1, wherein the junction and the classification channel satisfy the following relationship:
0.95×a≦b≦1.05×a
where a is the channel width of the junction; and b is the channel width of the classification channel.

6. The classification device according to claim 1, wherein the upwardly convex shape is an isosceles trapezoid bridging over the whole channel width.

7. The classification device according to claim 1, wherein the upwardly convex shape is an isosceles trapezoid bridging over the middle portion of the channel width.

8. The classification device according to claim 1, wherein the upwardly convex shape is an arc bridging the whole channel width.

9. The classification device according to claim 1, wherein the upwardly convex shape is an arc bridging the middle portion of the channel width.

10. The classification device according to claim 1, wherein the upwardly convex shape is a rectangle in the middle portion of the channel width.

11. The classification device according to claim 1, wherein the upwardly convex shape is an inverted V shape bridging over the middle portion of the channel width.

12. A method for classifying particles of a particle dispersion comprising
classifying the particles with the classification device according to claim 1.
